(19) United States
(12) Patent Application Publication
(10) Pub. No.: US 2025/0245619 A1
(43) Pub. Date: Jul. 31, 2025

(54) SYSTEMS AND METHODS FOR GROUP-BASED STACKING SIMULATION AND AUTOMATION

(71) Applicant: Walmart Apollo, LLC, Bentonville, AR (US)

(72) Inventors: Cai Gao, Sunnyvale, CA (US); Hui Zhi Yi, Plano, TX (US); Cong Guo, Danville, CA (US); Jason Klingman, Gentry, AR (US); Mikaela Hall, Phoenix, AZ (US); Mingang Fu, Palo Alto, CA (US)

(21) Appl. No.: 18/428,389

(22) Filed: Jan. 31, 2024

(51) Int. Cl. G06Q 10/087; G06F 30/17; G06F 113/20

(52) U.S. Cl. CPC G06Q 10/087; G06F 30/17; G06F 2113/20

(57) ABSTRACT

Systems and methods of generating a stacking solution for a three-dimensional base element are disclosed. A stacking solution generate generation request is received identifying a base element and a set of item containers and a plurality of bundles are generated. Each bundle of the plurality of bundles includes one or more of the containers selected from the set of item containers. Each of the plurality of bundles is assigned to a position within a stacking window of the base element and a stacking solution is generated including a sequential pick order for each of item containers in the set of item containers based on the assignment of the plurality of bundles within the stacking window.

### TECHNICAL FIELD

This application relates generally to stacking simulation and automation, and more particularly, to group-based pallet stacking solutions and automation.

### BACKGROUND

Efficient and stable construction of shipping units, such as shipping pallets, is a critical challenge for distribution logistics. In particular, highly heterogenous case elements and predetermined stacking sequences make finding efficient stacking solutions time and resource intensive. Current manual stacking processes may introduce air gaps or void spaces, creating inefficiencies in the total quantity of stackable elements. Additionally, current manual stacking processes may result in unstable stacking conditions, such as unbalanced elements, poorly supported elements, heavier elements being placed on other elements without sufficient structure to support the heavier elements, etc.

Some current systems apply a 3D bin packing problem to generate solutions for pallet packing. These systems may utilize offline bin packing solutions, in which the system has complete prior knowledge about the input items to be added to a bin, or online bin packing solutions, in which each input item is received and stacked sequentially without knowledge of parameters for forthcoming input items. Offline bin packing solutions require preselection of items to be included in a packed bin, preventing adjustments or modifications after the solution has been generated. Online bin packing solutions result in inefficiencies due to lack of knowledge regarding future items to be packed. Thus, both offline and online solutions are currently inadequate for generation of automated stacking solutions and automated implementation of generated solutions.

### SUMMARY

In various embodiments, a system including a non-transitory memory and a processor communicatively coupled to the non-transitory memory is disclosed. The processor is configured to read a set of instructions to receive a stacking solution generation request identifying a base element and a set of item containers and generate a plurality of bundles. Each bundle of the plurality of bundles includes one or more of the containers selected from the set of item containers. The processor is further configured to read the set of instructions to assign each bundle of the plurality of bundles to a position within a stacking window of the base element and generate a stacking solution including a sequential pick order for each of item containers in the set of item containers based on the assignment of the plurality of bundles within the stacking window.

In various embodiments, a computer-implemented method is disclosed. The computer-implemented method includes steps of receiving a stacking solution generation request identifying a base element and a set of item containers and generating a plurality of bundles. Each bundle of the plurality of bundles includes one or more of the containers selected from the set of item containers. The computer-implemented method further includes steps of assigning each bundle of the plurality of bundles to a position within a stacking window of the base element and generating a stacking solution including a sequential pick order for each of item containers in the set of item containers based on the assignment of the plurality of bundles within the stacking window. The stacking solution is configured to conform to one or more non-dimensional constraints.

In various embodiments, a non-transitory computer readable medium having instructions stored thereon is disclosed. The instructions, when executed by at least one processor, cause at least one device to perform operations including receiving a stacking solution generation request identifying a base element and a set of item containers and generating a plurality of bundles. Each bundle of the plurality of bundles includes one or more of the containers selected from the set of item containers. The instructions further cause the at least one device to perform operations including assigning each bundle of the plurality of bundles to a position within a stacking window of the base element. The stacking window comprises a plurality of vertical layers. The instructions further cause the at least one device to perform operations including generating a stacking solution including a sequential pick order for each of item containers in the set of item containers based on the assignment of the plurality of bundles within the stacking window. The stacking solution includes sequential stacking of item containers assigned to sequential vertical layers.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide pallet stacking solution generation and automated implementation, in accordance with some embodiments;

FIG. 2 illustrates a computer system configured to implement one or more processes, in accordance with some embodiments;

FIG. 3 illustrates a base element including a stacking window, in accordance with some embodiments;

FIGS. 4A-4F illustrate various orientations of an item container, in accordance with some embodiments;

FIG. 5 is a flowchart illustrating an automated grouping-based item container assignment and stacking method, in accordance with some embodiments;

FIG. 6 is a process flow illustrating various steps of the automated container assignment and stacking method of FIG. 5, in accordance with some embodiments;

FIG. 7 illustrates a base element having a plurality of item containers positioned at various orientations and locations within a stacking envelope of a selected base element according to a grouping-based stacking process, in accordance with some embodiments;

FIG. 8 is a flowchart illustrating an iterative stacking method, in accordance with some embodiments;

FIG. 9 is a flowchart illustrating a bundle generation method, in accordance with some embodiments;

FIG. 10 is a flowchart illustrating a bundle generation process, in accordance with some embodiments;

FIG. 11 is a flowchart illustrating a bundle evaluation process, in accordance with some embodiments;

FIG. 12 is a flowchart illustrating a grouping-based stacking process, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for generating pallet (e.g., bin) stacking solutions and implementing automated systems according to the generated stacking solutions. In various embodiments, a layered pallet stacking solution is generated. The layered pallet stacking solution may be based on specifications of a pallet and specifications of a set of three-dimensional item containers to be stacked on the pallet. An iterative searching method using block generator logic and layer generator logic is applied to select a set of item containers for each layer of a stack of layers associated with the pallet. The block generator is configured to identify a selection and orientation of various item containers for inclusion in each layer. The layer generator is configured to select a set of item containers and orientations that provides an optimal layer (e.g., a layer having a highest number of filled candidate blocks while meeting one or more stability constraints).

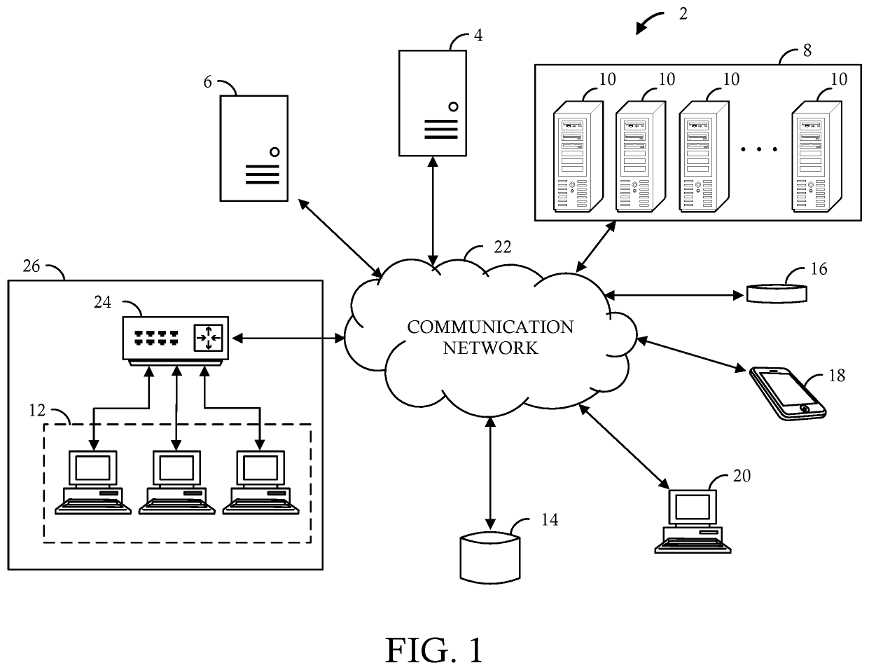

FIG. 1 illustrates a network environment 2 configured to provide pallet stacking solution generation and automated implementation, in accordance with some embodiments. The network environment 2 includes a plurality of devices or systems configured to communicate over one or more network channels, illustrated as a network cloud 22. For example, in various embodiments, the network environment 2 may include, but is not limited to, a stacking solution computing device 4, a web server 6, a cloud-based engine 8 including one or more processing devices 10, a database 14, and/or one or more user computing devices 16, 18, 20 operatively coupled over the network 22. The stacking solution computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the stacking solution computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the stacking solution computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as a logistics network environment. In some embodiments, the stacking solution computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the stacking solution computing device 4, for example. The workstation(s) 12 may communicate with the stacking solution computing device 4 over the communication network 22. The workstation(s) 12 may send data to, and receive data from, the stacking solution computing device 4. For example, the workstation(s) 12 may transmit data related to tracked operations performed at the physical location 26 to stacking solution computing device 4.

Although FIG. 1 illustrates three user computing devices 16, 18, 20, the network environment 2 may include any number of user computing devices 16, 18, 20. Similarly, the network environment 2 may include any number of the stacking solution computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the stacking solution computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the first user computing devices 16, 18, 20 may communicate with the web server 6 over the communication network 22. For example, each of the user computing devices 16, 18, 20 may be operable to view, access, and interact with a website, such as a logistic planning website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as providing item container information for one or more facilities, packing lines, etc. The website may capture these activities as user session data, and transmit the user session data to the stacking solution computing device 4 over the communication network 22. The website may also allow the user to interact with one or more of interface elements to perform specific operations, such as selecting one or more items for further processing.

In some embodiments, the web server 6 transmits a stacking solution request to the stacking solution computing device 4. The stacking solution request may include item container information, pallet parameters, stacking constraints, and/or any other suitable stacking parameters. The stacking solution computing device 4 may, in response to receiving the stacking solution request, may generate a stacking solution data structure representative of an optimal stacking solution for the provided and/or obtained parameters and one or more stacking constraints. The stacking solution includes a set of layer solutions for each layer to be generated on the packing element (e.g., pallet). The stacking solution computing device 4 may provide the stacking solution to one or more workstations 12. In response to receiving the stacking solution, the one or more workstations 12 may operate one or more automated stacking systems to generate and/or facilitate generation of a pallet including a set of item containers stacked in correspondence with the generated stacking solution.

The stacking solution computing device 4 is further operable to communicate with the database 14 over the communication network 22. For example, the stacking solution computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the stacking solution computing device 4, in some embodiments, the database 14 may be a local storage device, such as a hard drive, a non-volatile memory, or a USB stick.

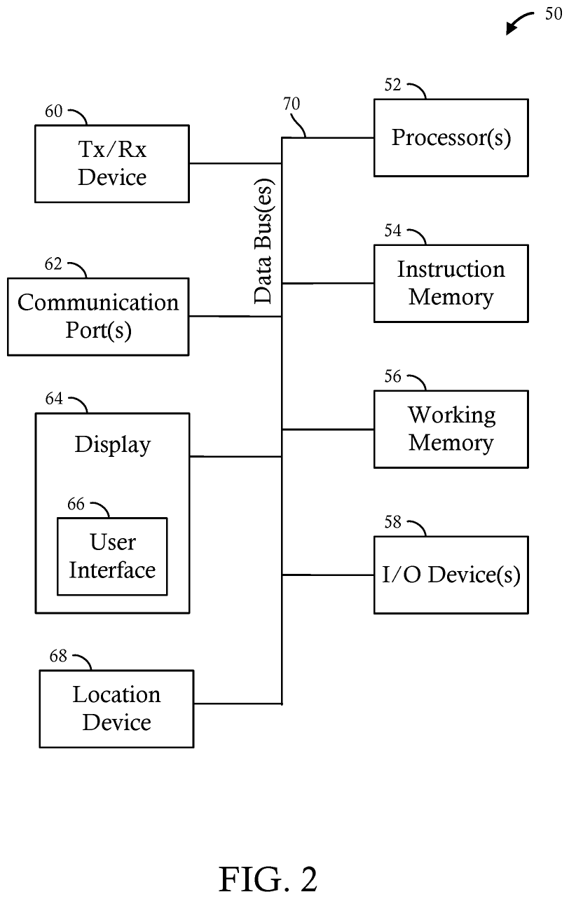

FIG. 2 illustrates a block diagram of a computing device 50, in accordance with some embodiments. In some embodiments, each of the stacking solution computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generating and automatically implementing stacking solutions, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NOSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

With reference again to FIG. 1, in some embodiments, a stacking solution computing device 4 is configured to generate a optimal stacking configuration for arranging and stacking item containers at each of a plurality of layers associated with a selected base element (e.g., pallet). Each layer solution may include one or more item containers having one or more selected orientations. For example, a first layer solution may include a plurality of item containers each having a size (e.g., a height, width, and length), a weight, one or more stacking constraints, and/or any other suitable parameters. A position and/or orientation of each of one or more item containers may be selected based on both an individual layer solution and one or more stacking constraints of a prior layer.

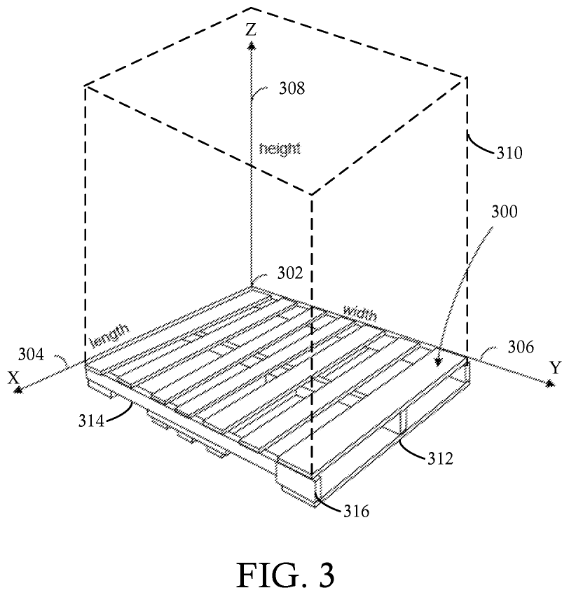

FIG. 3 illustrates a base element 300 (e.g., a pallet, bulk container, support carton, etc.) configured to receive a set of item containers thereon. The base element 300 includes a three-dimensional structure having a length 304, a width 306, and a height 308. The base element 300 is illustrated within a coordinate system 302 having axes corresponding to a length dimension, a width dimension, and a height dimension of the base element 300. Although embodiments are illustrated having an aligned coordinate system 302, it will be appreciated that the disclosed systems and methods may be configured to operate in a coordinate system 302 having one or more axes aligned at an angle with respect to one or more of a length dimension, a width dimension, and/or a height dimension of the base element 300. In the illustrated embodiment, the three-dimensional structure includes a flat top, although it will be appreciated that a base element 300 may include one or more vertical walls extending from a base portion in one or more dimensions, such as one or more vertical walls extending in a Z-direction from the base element 300.

The base element 300 is configured to receive a set of item containers (e.g., individual bulk items, containers including one or more items, boxes, bags, etc.) within a stacking envelope 310. The stacking envelope 310 includes a length 312, width 314, and a height 316 that defines a three-dimensional area for receiving item containers. One or more dimensions of the stacking envelope 310, such as a length 312 and/or a width 314, may be substantially equal to a corresponding dimension, such as a length 304 and/or a width 306, of the base element 300. Additionally and/or alternatively, one or more dimensions of the stacking envelope 310 may extend beyond one or more dimensions, such as a height 316, may extend beyond a corresponding dimension, such as height 308, of the base element 300. The stacking envelope 310 defines the maximum area into which item containers can be positioned for transport by the base element 300.

One or more base parameters may be associated with each base element 300. For example, in various embodiments, one or more base parameters may include, but are not limited to, parameters defining aspects of the stacking envelope, stacking parameters (e.g., maximum weight, maximum stacked height, etc.), item restrictions (e.g., restrictions on types or classes of items from being stacked on the base element 300), and/or any other suitable parameters.

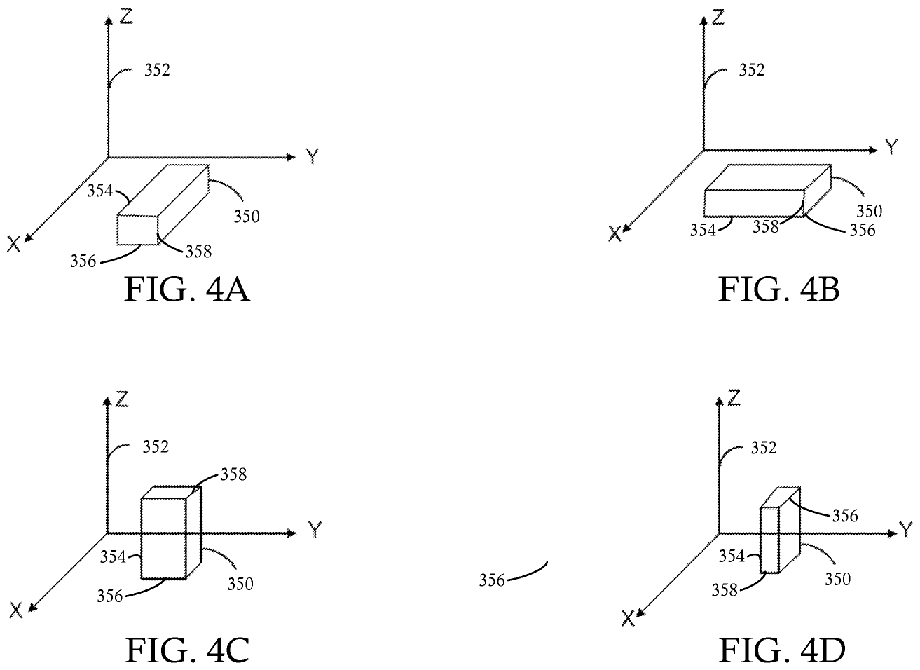

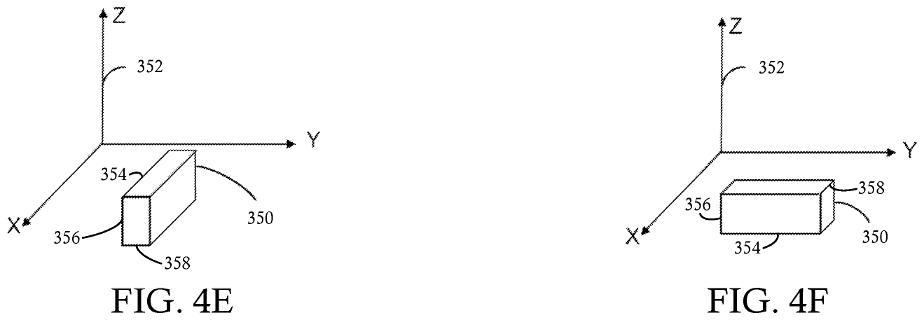

Item containers (e.g., individual bulk items, containers including one or more items, boxes, bags, etc.) may be positioned both horizontally and vertically (e.g., stacked) within the stacking envelope 310. FIGS. 4A-4F illustrate an item container 350 include a length 354, a width 356, and a length 358 illustrated within a coordinate system 352. The coordinate system 302 and the coordinate system 352 may be the same coordinate system, corresponding coordinate systems, and/or related (e.g., convertible) coordinate systems. The stacking solution computing device 4 may be configured to select an orientation for a plurality of item containers 350 from various orientations, such as those illustrated in FIGS. 4A-4F, and a position with respect to the stacking envelope 310 of the base element 300, as discussed in greater detail below.

FIGS. 4A-4F illustrate the item container 350 in one of six potential orientations, for example, having different faces along each of the X-Y, X-Z, and Y-Z planes. A first orientation, such as the orientation illustrated in FIG. 4A, may be defined as a normal orientation where the length dimension 354 of the item container 350 is oriented on the X-axis of the coordinate system 352, the width dimension 356 of the item container 350 is oriented on the Y-axis of the coordinate system 352, and the height dimension 358 of the item container 350 is oriented on the Z-axis of the coordinate system 352. Although embodiments are discussed herein defining FIG. 4A as a normal orientation, it will be appreciated that any initial orientation of an item container 350 may be defined as a normal, or default, orientation. In the embodiment defining the orientation of FIG. 4A as a normal orientation: FIG. 4B illustrates a normal-rotated orientation such that the item container 350 is oriented with a width dimension 356 on the X-axis of the coordinate system 352, a length dimension 354 on the Y-axis of the coordinate system 352, and a height dimension 358 on the Z-axis of the coordinate system 352; FIG. 4C illustrates an end orientation with a height dimension 358 on the X-axis, a width dimension 356 on the Y-axis, and a length dimension 354 on the Z-axis; FIG. 4D illustrates an end-rotated orientation with a width dimension 356 on the X-axis, a height dimension 358 on the Y-axis, and a length dimension 354 on the Z-axis; FIG. 4E illustrates a side orientation with a length dimension 354 on the X-axis, a height dimension 358 on the Y-axis, and a width dimension 356 on the Z-axis; FIG. 4F illustrates a side-rotated position with a height dimension 358 on the X-axis, a length dimension 354 on the Y-axis, and a width 356 dimension on the Z-axis. Although embodiments are discussed herein including orientations of the item container 350 having dimensions oriented on a corresponding axis, it will be appreciated that item container 350 may be oriented off-axis, e.g., with each of the dimensions of an item container 350 being positioned partially along at least two axes of the coordinate system 352. One or more container parameters may be associated with each item container 350. The one or more container parameters may include, but are not limited to, a limitation on positioning of the item container in one or more of the orientations shown in FIGS. 4A-4F, limitations on positioning within a stacking envelope 310 (e.g. a restriction on corner stacking), one or more dimensional parameters (e.g., width, height, length), one or more physical parameters (e.g., a maximum supportable load, weight, density, temperature requirements, etc.), one or more content parameters (e.g., one or more categories of items stored within each item container, etc.), one or more stacking parameters, and/or any other suitable parameters.

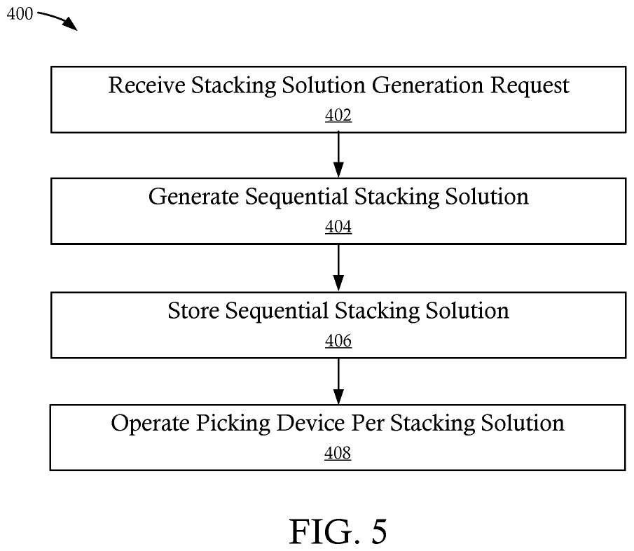

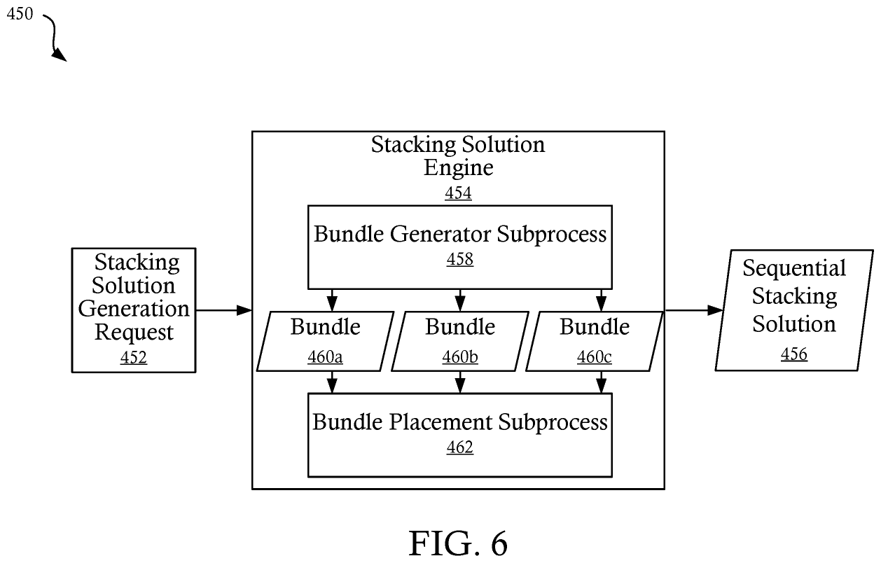

FIG. 5 is a flowchart illustrating an automated grouping-based item container assignment and stacking method 400, in accordance with some embodiments. FIG. 6 is a process flow 450 illustrating various steps of the automated container assignment and stacking method 400, in accordance with some embodiments. The automated container assignment and stacking method 400 is configured to generate a stacking solution (e.g., a sequential stacking plan) for positioning a set of item containers on a selected base element 300. The automated container assignment and stacking method 400 may be implemented by any suitable system, device, engine, module, etc., such as, for example, the stacking solution computing device 4. Although specific embodiments are discussed herein, it will be appreciated that the automated container assignment and stacking method 400 may be implemented, in part or in whole, by one or more additional and/or alternative systems.

At step 402, a stacking solution generation request 452 is received. The stacking solution generation request 452 may include one or more parameters for generating a stacking solution, such as, for example, a set of item containers [symbol] (e.g. an ordered list of item containers), identification and/or selection of a base element 300, etc. In some embodiments, the stacking solution generation request 452 may include a reference to one or more parameters stored in a database, such as database 14. The stacking solution generation request 452 may be generated by a user device, such as user computing device 16, interacting with a website, by an automated process (e.g., an automated ordering and shipping control process) implemented by any suitable system, such as a workstation 12, and/or any other suitable system or device. The stacking solution generation request 452 may be received by any suitable engine and/or module implemented by a corresponding device, such as a stacking solution engine 454 implemented by a stacking solution computing device 4. Although specific embodiments are discussed herein, it will be appreciated that additional and/or alternative systems, devices, engines, modules, etc. may generate and/or receive a stacking solution generation request 452.

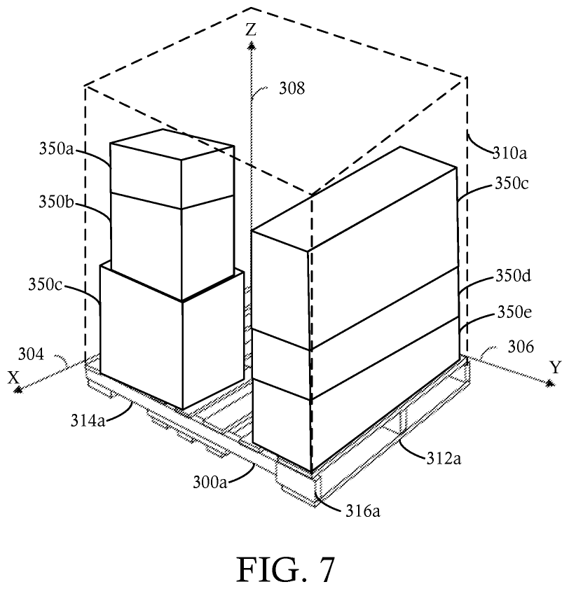

At step 404, a sequential stacking solution 456 is generated for the received stacking solution generation request 452. The sequential stacking solution 456 includes position (e.g., X, Y, Z positions in coordinate system 302) and an ordered placement for each item container in the set of item containers [symbol] . FIG. 7 is a visual representation of a sequentially-loaded base element 300a including a plurality of item containers 350a-350f positioned at various orientations and locations within a stacking envelope 310a of the base element 300a, in accordance with some embodiments. As shown in FIG. 7, a sequential stacking solution 456 may include horizontally stacked and/or vertically stacked item containers 350a-350f.

In some embodiments, the position and/or ordered placement of the item containers 350a-350f may be defined based on a division of sequential vertical layers 320a-320c on a Z-axis of the coordinate system 302 within a stacking envelope, such as stacking envelope 310a. Each sequential vertical layer 320a-320c may include one or more item containers 350a-350f positioned in a horizontal plane 322a-322c (e.g., a plane defined by the X-Y axes of the coordinate system 302) at a corresponding height of the vertical layer 320a-320c. In some embodiments, a stacking constraint between layers for any two item containers (bᵢ, bⱼ ∈ [symbol] ), where the stacking sequences differ, e.g., s(bᵢ)>s(bⱼ), enforces a constraint that bⱼ cannot be positioned above bⱼ (e.g., bᵢ, bⱼ cannot be positioned in a manner that results in overlap within the X-Y plane).

The sequential stacking solution 456 is generated to satisfy one or more stability constraints, e.g., stacking parameters, with respect to both individual item containers 350a-350f and the base element 300. Stability constraints may include, but are not limited to, individual item container 350a-350f constraints (e.g., maximum supportable load, position restraints, layer restraints, angle and/or rotation constraints, etc.), corner stability constraints, base stability constraints, etc. Item container constraints may include positional constraints, for example, constraints regarding positions on a pallet of the individual item container 350 (e.g., restriction the item container from placement on an outer edge of a base element 300) restrictions on the angle of an item container 350 with respect to an edge of the base element 300 (e.g., outward leaning item containers having an angle tilting towards an outer direction of a base element 300), and/or any other suitable item container constraints.

Corner stability constraints may include aggregate support requirements, such as static support provided by one or more item containers 350 positioned in one or more layers beneath a corner (e.g., X-Y plane edge) of a current layer (e.g., requiring a higher percentage of support from a footprint area of item containers 350 stacked beneath corner item containers of the current layer) and/or dynamic support (e.g., prohibiting column stacking such that an item container bᵢ is the only item container that overlaps with an item container bⱼ in an X-Y plane and bⱼ is the only item container that overlaps with an item container bⱼ in the X-Y plane for the corresponding layers). The pallet base stability constraints may include a constraint on average percentage of a footprint of item containers, up to a designated height, that receive support from item containers positioned in lower layers.

In some embodiments, the stacking solution engine 454 is configured to apply a layer-by-layer process to generate the sequential stacking solution 456. The layer-by-layer process may include generating individual layer solutions sequentially from a bottom layer 320a (e.g., lowest Z-axis position) to a top layer 320c (e.g., highest Z-axis position). The layer-by-layer process may reduce an overall stacking problem to a smaller set of individual problems and corresponding solutions, reducing the dimensions of a stacking solution for the stacking solution generation request 452 from a single, three-dimensional (3D) bin packing problem (BPP) (3DBPP) to a set of two-dimensional (2D) BPP (2DBPP) and/or may allow a relaxation of a hard constraint for a picking sequence within each layer and/or between layers. By reducing the stacking solution to a set of 2DBPP solutions, the disclosed systems and methods may reduce the computational burden and complexity of each individual pallet solution, allowing a large number of heterogeneous sets of item containers 350 to be assigned to a plurality of base elements 300 within a time frame suitable for deployment.

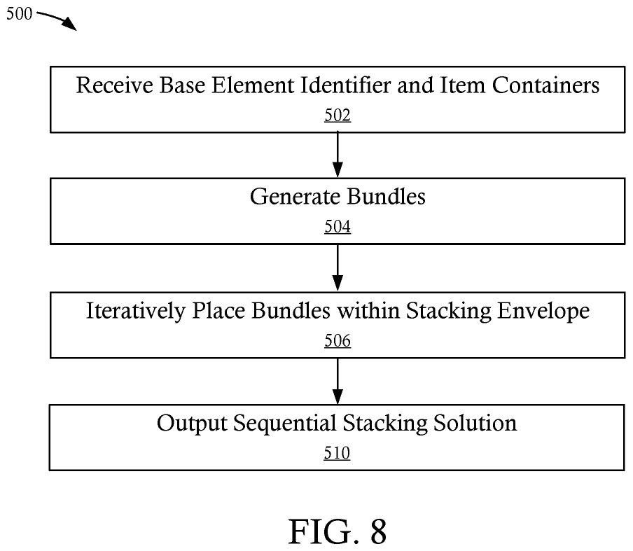

In some embodiments, the stacking solution engine 454 applies an iterative process to generate a stacking solution for each vertical layer 320a-320c in a stacking envelope 310a of a corresponding base element 300a. FIG. 8 is a flowchart illustrating an iterative stacking method 500, in accordance with some embodiments. The iterative stacking method 500 may be implemented by any suitable process, module, engine, etc., such as the stacking solution engine 454. At step 502, a base element identifier and a set of item containers [symbol] are received.

At step 504, one or more bundles 460 are generated. Each of the bundles 460a-460c includes a subset of the item containers [symbol] combined into a single unit and treated as a single stackable element, e.g., a “super” item container that can be positioned within a stacking envelope 310. Each of the one or more bundles 460a-460c may be generated by applying one or more horizontal and/or vertical bundling rules (e.g., strategies), such as utilizing horizontal stacking of same or similar-height item containers 350a-350f to generate bundles 460a-460c having uniform surfaces (e.g., a 1×2 double horizontal bundle, a 2×2 quadra-horizontal bundle, etc.) and/or vertical stacking to a target height based on one or more additional constraints (e.g., utilizing item containers 350a-350f that allow side stacking, end stacking, corner stacking, omitting item containers 350a-350f associated with certain categories, base support ratios, low-aspect ratios, etc.). Although specific embodiments are discussed herein, it will be appreciated that any suitable criteria can be applied to generate one or more bundles of two or more item containers 350a-350f.

In some embodiments, bundles 460a-460c are generated by a bundle generation subprocess 458 that generates candidate bundles of one or more predetermined heights (e.g., one or more distances on a Z-axis) and positioned within a stacking window 310a by a bundle placement subprocess 460. The bundle generator subprocess 458 may generate multiple candidate bundles 460a-460c of different predetermined heights and select one of the candidate bundles having a first predetermined height. For example, a bundle generator subprocess 458 may generate four candidate bundle configurations each having one of four corresponding heights, e.g., a first candidate bundle having a “highest case height”, a second bundle having a “mean case height”, a third bundle having a “median case height”, and a fourth bundle having a “most frequent case height”. One of the four candidate bundles may be output (e.g., selected for stacking within a stacking envelope 310a), as discussed in greater detail below. Although specific embodiments are discussed herein, it will be appreciated that the bundle generator subprocess 458 can be configured to generate any number of bundle configurations having corresponding heights.

The bundle generator subprocess 458 may generate candidate bundles by bundling shorter item containers 350a-350f together into structured bundles to match one or more higher target heights and/or leveraging side-stacking and/or end-stacking for certain item containers 350 to match lower target heights, for example, when side-stacked and/or end-stacked item containers 350a-350f are within one or more required constraints. By grouping item containers 350a-350f in structured bundles, the bundle generation subprocess 458 provides enhanced control over placement and alignment during generation of a sequential stacking solution 456.

In some embodiments, the bundle generator subprocess 458 may define one or more types of bundles 460a-460c, such as a vertical bundle, a solo-side-stacked bundle, etc. A vertical bundle may include a stack of N item containers where each item container 350a-350f is placed directly on top of another. The stack may be represented as VBⱼ=b₁, b₂, . . . , bₙ with each item container bᵢ aligned vertically over a prior item container, bᵢ₋₁. The stack (e.g., VBⱼ) may have a minimum base overlapping ratio constraint (e.g., r=0.8) and a total height of the stack is a sum of the heights of all individual item containers, which may be denoted as H=Σᵢ₌₁ⁿhᵢ, where hᵢ is a height of the i-th item container. A solo-side-stacked bundle may be defined as a single item container, bᵢ, that is ω-weight-side-stackable and that is positioned in a side-stacked position. A horizontal bundle may be defined as two or more item containers 350a-350f stacked side-by-side to define a larger top bundle footprint as compared to each of the two or more item containers 350a-350f individually. The bundle generator subprocess 458 may select item containers 350a-350f having substantially similar heights for inclusion in a side-by-side stack. A mixed bundle may be defined as a stack of item containers 350a-350f utilizing two or more other bundle types, such as a bundle containing two or more side-by-side stacked item containers 350a-350f with at least one of the item containers being a solo-side-stack bundle item and/or including at least one horizontally stacked item container that itself is a vertical bundle of item containers. Although specific embodiments are discussed herein, it will be appreciated that any suitable combination of stacking and/or orientations of item containers 350a-350f may be used to generate bundles.

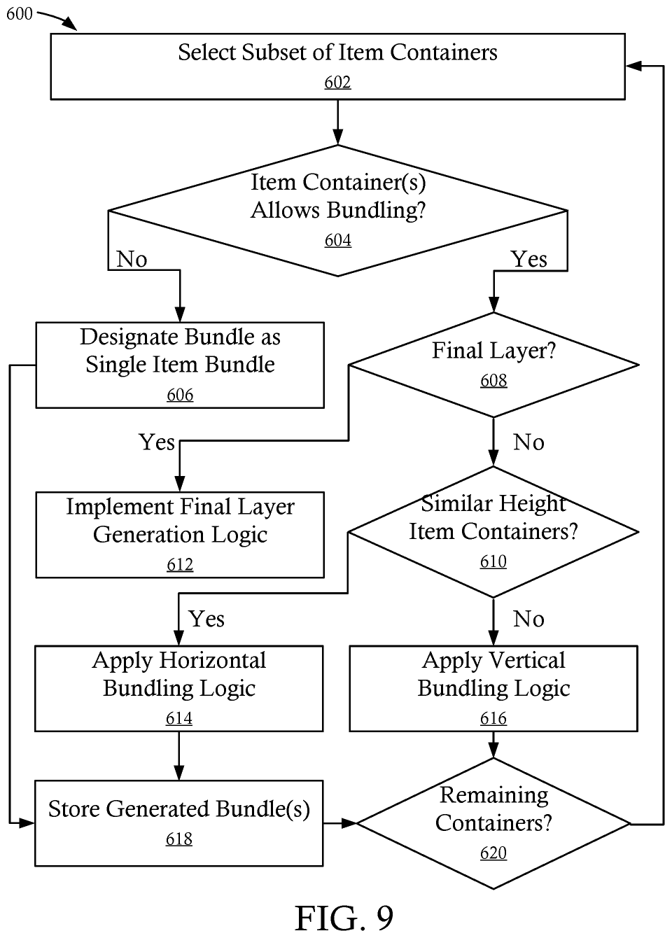

FIG. 9 is a flowchart illustrating a bundle generation method 600, in accordance with some embodiments. At step 602, a subset of the item containers [symbol] 350a-350f is selected. The subset of the item containers B may include the entire set of item containers [symbol] or a partial set of the item containers [symbol] (e.g., remaining unstacked item containers, a layer-specific set of item containers, etc.). In some embodiments, the subset of the item containers [symbol] may include one or more previously generated bundles.

At step 604, for each item container 350a-350f in the subset of the item containers [symbol] , a determination is made whether the item container 350a-350f allows bundling. The determination may be based on container constraint data associated with a selected item container 350a-350f. In one example, constraint data may include a data element indicating allowability or restriction of inclusion of an item container 350a-350f within a bundle. As another example, a determination may be made based on an item category, container strength, container contents, etc. When the determination at step 604 indicates an item container 350a-350f should not (e.g., may not, cannot, etc.) be included in a bundle, the bundle generation method 600 proceeds to step 606 and designates the current item container 350a-350f for single container bundling logic (e.g., the single item container 350a-350f is marked as a complete bundle and output for inclusion in a stacking solution as a bundle containing the single corresponding item container). When the determination at step 604 indicates a current item container 350a-350f may be included in a bundle, the bundle generation method 600 proceeds to step 608.

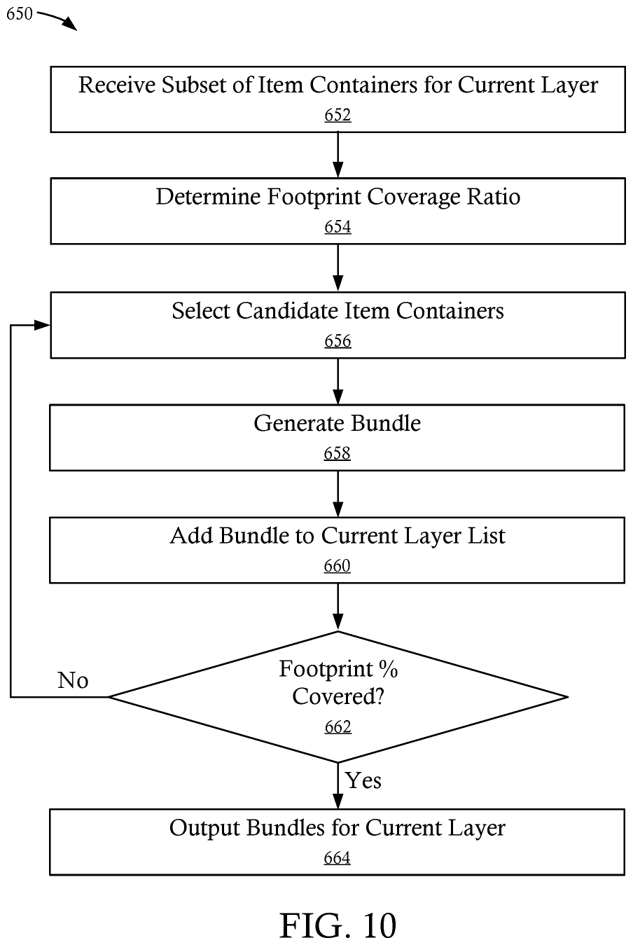

At step 608, a determination is made whether a current layer being generated is a final (e.g., top layer) within a stacking envelope 310. When the current layer is not the final layer, the bundle generation method 600 proceeds to step 610, where a determination is made whether the current subset of the item containers [symbol] and/or previously defined bundles have a similar height. Where the current layer is the final layer, the bundle generation method proceeds to step 612. At step 612, a final layer is generated by determining if a total footprint of the remaining bundles covers a predetermined percentage of a prior-layer footprint. When the determination indicates the remaining bundles cover a predetermined percentage of prior-layer footprint above a predetermined threshold (e.g., about 70%, about 75%, about 80%, about 85%, about 90%, etc.), the final layer is generated according to the process described with respect to steps 614-618. When the determination indicates the remaining bundles do not cover the predetermined percentage of the prior-layer footprint, the remaining bundles and/or containers are arranged to reduce the overall height of the item container stack, e.g., by positioning one or more item containers such that a dimension extending on the Z-axis is less than a dimension extending along at least one of the X-axis or the Y-axis. If the current subset of the item containers [symbol] and/or the previously defined bundles have a similar (e.g., uniform) height, the bundle generation method 600 proceeds to step 614 and applies horizontal bundling logic to generate side-by-side stacked bundles. FIG. 10 is a flowchart illustrating a bundle generation process 650, in accordance with some embodiments.

At step 652, the current subset of the item containers [symbol] for the current vertical layer 320a-320c is received and, at step 654, a footprint coverage ratio is determined. The footprint coverage ratio represents a percentage (e.g., ratio) of the current layer footprint (e.g., horizontal plane area) that is to be covered by a set of generated bundles. The footprint coverage ratio may be selected based on any suitable criteria, such as, for example, one or more ratio limits and/or requirements (e.g., each bundle must cover at least X % but cannot cover more than Y % of a current layer footprint, a current bundle may cover between X and Y % of an uncovered portion of a current vertical layer footprint, at least X % of a current footprint must be covered by generated bundles, etc.).

At step 656, a set of candidate item containers 350a-350f is selected for inclusion in a bundle. The set of candidate item containers may include all item containers 350a-350f having a similar height (e.g., all item containers having a height within a range having a small variance), a random selection of item containers 350a-350f having a similar height, etc. The set of candidate item containers may be selected based on one or more additional parameters, such as, for example, weight parameters, layer support (e.g. loadbearing) parameters, stacking position parameters, etc.

At step 658, a bundle 460a-460c is generated. The bundle 460a-460c includes at least a subset of the set of candidate item containers. The container bundle may include the subset of the set of candidate item containers that optimizes one or more parameters, such as, for example, footprint ratio coverage, loadbearing value, stacking position, etc. At step 660, the generated bundle 460a-460c is added to a list of bundles for inclusion in a current layer. The list of bundles may include all potential bundles that may added to a current layer of a stacking envelope 310 and/or a fixed set of bundles that are to be included in the current layer of the stacking envelope 310.

At step 662, a determination is made whether the footprint of the current vertical layer 320a-320c is covered by the bundles in the list of bundles. For example, the determination may be based on a current overall footprint coverage ratio for a current vertical layer 320a-320c. When the overall footprint coverage ratio for the set of bundles in the list of bundles is less than (or equal to in some embodiments) the predetermined value, the horizontal bundling process 650 returns to step 656. The horizontal bundling process 650 iteratively repeats steps 656-662 until the determination indicates that the overall footprint coverage ratio is greater than (or equal to in some embodiments) the predetermined value. When the overall footprint coverage ratio for the set of bundles in the list of bundles is greater than or equal to a predetermined value, the horizontal bundling process 650 proceeds to step 664 and the set of bundles 460a-460c for inclusion in a current layer is output.

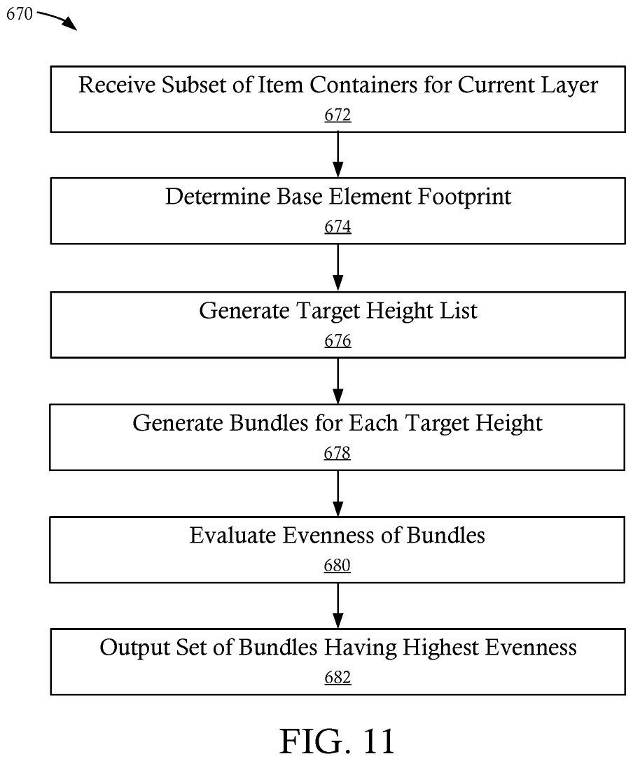

With reference again to FIG. 9, if the determination at step 610 indicates the current subset of the item containers [symbol] and/or the previously defined bundles have different heights, the bundle generation method 600 proceeds to step 614 and applies multiple target height bundling logic to generate candidate bundles having one of a plurality of heights, such as one or more of a highest case height, a mean case height, a median case height, or a most frequent case height. FIG. 11 is a flowchart illustrating a bundle evaluation process 670, in accordance with some embodiments.

At step 672, the current subset of the item containers [symbol] (e.g., the currently unstacked item containers) is received and, at step 674, a set of candidate item containers is selected for bundling based on a footprint of the corresponding base element 300a. The footprint may define one or more slots, such as one or more available spaces, one or more optimized spaces, one or more corner spaces, etc. The set of candidate item containers may include item containers selected from the current subset that satisfy one or more parameters of an open portion of the base element footprint, such as, for example, being available for corner and/or side stacking.

At step 676, a target height list is generated. A target height list may include two or more target heights for vertically stacked bundles. The target heights may include one or more heights generated based on the current subset of item containers and/or a set of previously generated bundles. For example, the set of target heights may include, but is not limited to, a highest case height, a mean case height, a median case height, a most frequent case height, etc.

At step 678, target bundles are built for each target height in the target height list. Target bundles may be generated utilizing, partially overlapping subsets, entirely overlapping subsets, or non-overlapping subsets of the subset of the item containers [symbol] . Each of the target bundles is configured to optimize one or more parameters, such as, for example, footprint ratio coverage, loadbearing value, stacking position, evenness, etc.

At step 680, the generated target bundles are evaluated based on evenness of the bundle distribution and, at step 682, a set of target bundles 460a-460c having the highest evenness value are output. As used herein, evenness may refer to a variation in one or more surface areas defined by a multi-height bundle. For example, surface area variations may be determined for a top surface area defined of a target bundle and/or one or more side surface areas.

With reference again to FIG. 9, at step 618, one or more generated bundles 460a-460c (e.g., single item bundles generated at step 606, horizontally-grouped bundles generated at step 614, vertically-grouped bundles generated at step 616, etc.) are stored in a data store, such as database 14. At step 620, a determination is made whether additional item containers 350a-350f are available for bundling. When additional item containers are available, the bundle generation method 600 returns to step 602 and selects a subsequent, reduced, alternative, etc. subset of item containers for bundling. When additional item containers are not available, the bundle generation method 600 exits and the generated bundles 460a-460c are output for use in additional processes.

With reference again to FIG. 8, at step 506 of the iterative stacking method 500, a sequential stacking solution 464 is generated by iteratively positioning each of the generated bundles 460a-460c within the stacking envelope 310a. The sequential stacking solution 464 includes placement of bundles 460a-460c within a stacking envelope 310a to satisfy one or more stacking requirements. In some embodiments, a stacking surface of a current vertical layer 320a-320c is defined by a coverage footprint of the prior vertical layer 320a-320c. For example, a first vertical layer 320a includes a surface area defined by the surface area of the base element 300a, a second vertical layer 320b includes a surface area defined by the coverage footprint of the stacked set of item containers selected for the first vertical layer 320a, and the third vertical layer 320c includes a surface area defined by the coverage footprint of the stacked set of item containers selected for the second vertical layer 320b.

In some embodiments, one or more stacking constraints and/or priorities may be applied to generate a sequential stacking solution 456. For example, a sequential stacking solution 456 may be generated by sorting each of the available item containers and/or bundles in height order (e.g., descending and/or ascending Z-axis height order) and applying one or more predetermined stacking priorities. The predetermined stacking priorities may include, but are not limited to, stacking of tallest bundles at the corner spaces of a base element 300 in a first vertical layer 320a and subsequent stacking of remaining groups on non-corner spaces of the first vertical layer 320a and subsequent vertical layers 320b, 320c.

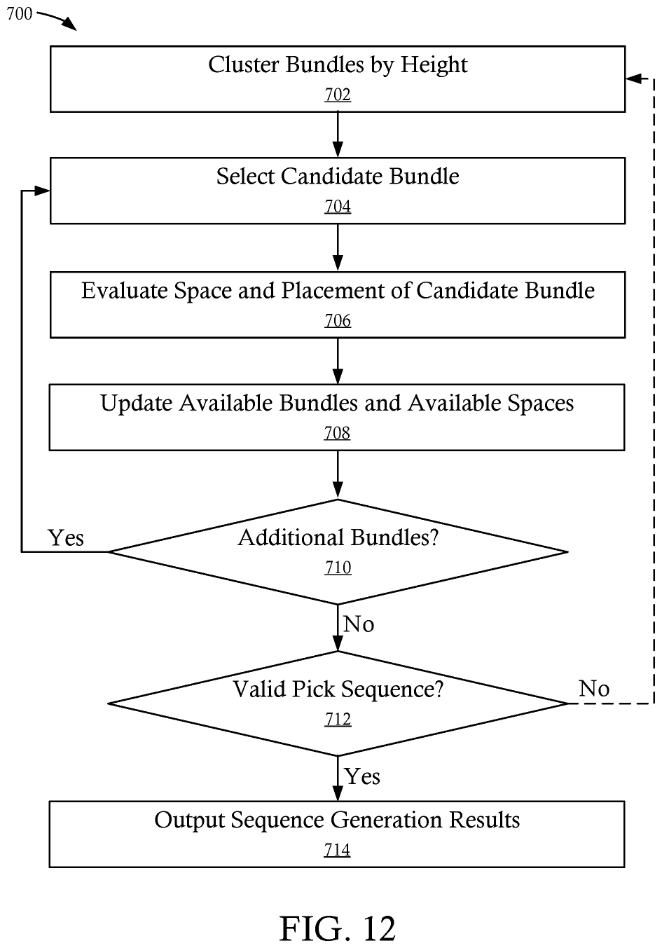

In some embodiments, a bundle placement subprocess 460 is configured to implement a grouping-based stacking process to generate a stacking solution. The grouping-based stacking process may include a tabu-based search process for identifying optimal bundle placement within a stacking envelope 310a. FIG. 12 is a flowchart illustrating a grouping-based stacking process 700, in accordance with some embodiments. At step 702, one or more clustering algorithms are applied to generate groups of bundles having similar heights. The groups of bundles may be sorted in descending height order.

At step 704, a bundle is selected and, at step 706, a space evaluation is performed to place the selected bundle within the stacking envelope 310a. Each bundle may be positioned at one or more potential locations and one or more checks may be performed to determine if placement of a bundle at a selected position conforms with one or more requirements. For example, in some embodiments, for each potential position, a check is performed to confirm that a bundle has sufficient support from one or more bundles positioned vertically beneath the current bundle and/or whether the bundle violates a picking sequence constraint.

Bundles may be selected and/or placed in descending height order and based on an inclusion in a corresponding group of bundles as determined by the one or more clustering algorithms. For example, during each iteration of step 706, a bundle is selected from a remaining group of bundles having the highest Z-axis height. If the bundle is the first bundle from the group of bundles to be selected, the grouping-based stacking process 700 attempts to position the bundle within a lowest corner of the stacking envelope 310a, e.g., the corner of the stacking envelope 310a having the lowest aggregate height. If the current bundle cannot be positioned at the lowest corner (e.g., due to violating one or more requirements such as having sufficient support), each of the remaining corners of the stacking envelope 310a may be evaluated in ascending height order. If the current bundle cannot be placed at any of the corner positions of the stacking envelope 310a, non-corner stacking spaces are evaluated.

If the current bundle is not the first bundle to be selected from a group of bundles (e.g., the current bundle is the second or subsequent bundle selected from a group of bundles), the grouping-based stacking process 700 first attempts to position the bundle in a dimensional-fit space adjacent to, e.g., in the neighborhood of, a bundle selected from the same group of bundles. If no such dimensional-fit space exists or adjacent dimensional-fit spaces violate one or more requirements (e.g., support requirements), nonadjacent dimensional-fit spaces are evaluated for placement of the current bundle.

At step 708, a set of available bundles and a set of available dimensional-fit spaces are updated to remove the bundle and the dimensional-fit spaces selected at steps 704 and 706. At step 710, a determination is made whether additional bundles need to be placed (e.g., whether the set of available bundles includes one or more bundles). If additional bundles remain to be placed, the grouping-based stacking process 700 returns to step 704 and selects a next bundle, e.g., a bundle from the current highest group of bundles having bundles remaining to be stacked. The grouping-based stacking process 700 iteratively repeats steps 704-708 until all bundles in a set of bundles have been placed and/or until there are no dimensional-fit spaces capable of receiving the remaining bundles in the set of available bundles. The grouping-based stacking process 700 then proceeds to step 710.

At step 712, a pick sequence (e.g., stacking sequence) for the placement of the bundles in steps 704-708 is validated. A valid pick sequence allows for positioning of the selected bundles at the identified locations without violating one or more picking constraints. For example, a base element 300 may be required to be filled in a designated order, e.g., front to back, back to front, by weight distribution, etc. If the pick sequence is validated, the grouping-based stacking process proceeds to step 714. If the pick sequence is not validated, the grouping-based stacking process 700 may return to step 704 and implement one or more alternative and/or additional constraints to generate a different stacking solution. Alternatively, the grouping-based stacking process may proceed to step 714.

At step 714, an output of the grouping-based stacking process 700 is generated. When the pick sequence is validated, the output may include the validated pick sequence and corresponding placement of each bundle within a stacking envelope 310a. In some embodiments, prior to generating an output, each bundle in the stacked set of bundles included within the stacking envelope 310a may be deconstructed into individual item container identifiers to allow for picking and/or placement of each individual item container. When the pick sequence is not validated, the output may include an error and/or indication of no-valid picking sequence for the identified set of item containers/bundles.

With reference again to FIG. 8, at step 508, a sequential stacking solution 456 is output. The sequential stacking solution 456 includes the validated picking sequence and placement location (e.g., X-Y-Z position within a stacking envelope 310a and orientation within the coordinate system 302) for each item container 350a-350f to be stacked within a stacking envelope 310a. The sequential loading solution may be output to and stored in a data store, such as database 14 and/or may be provided to one or more additional devices, modules, engines, etc. for use in one or more additional processes, as described herein.

With reference again to FIG. 5, at step 406, the sequential stacking solution 456 may be stored in one or more datastores, such as a database 14. At step 408, a picking device 470 may be operated according to the sequential stacking solution 456 to generate a physical stack of item containers 350a-350f on a base element corresponding to the base element 300a and the set of item containers 350a-350f represented in the sequential stacking solution 456. The picking device 470 may be partially and/or fully automated, may be configured to operate within a designated area, and/or may be integrated with additional systems and/or devices, such as additional picking devices, transportation devices, and/or packing devices configured to obtain item containers and/or transport item containers to a picking location.

In some embodiments, the sequential stacking solution 456 defines a relaxed layer picking sequence constraint. For example, the sequential stacking solution 456 may allow for positioning of two or more item containers 350 in a given layer in any order (e.g., stacking of bᵢ prior to stacking of bⱼ or stacking of bⱼ prior to stacking of bᵢ, etc.). The relaxed picking sequence constraint may facilitate automated picking and stacking of item containers 350 for a given base element 300.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive a stacking solution generation request identifying a base element and a set of item containers;
generate a plurality of bundles, wherein each bundle of the plurality of bundles includes one or more of containers selected from the set of item containers;
assign each bundle of the plurality of bundles to a position within a stacking window of the base element;
generate a stacking solution including a sequential pick order for each of item containers in the set of item containers based on the assignment of the plurality of bundles within the stacking window.

2. The system of claim 1, wherein the processor is configured to generate the plurality of bundles by:
selecting a first item container from the set of item containers;
determining eligibility of the first item container for bundling with one or more additional item containers;
when the first item container is not eligible for bundling, generating a single item bundle including the first container;
when the first container is eligible for bundling, generating a multi-item bundle by selecting one or more additional items for bundling with the first container.

3. The system of claim 2, wherein a multi-item bundle is generated by applying at least one of a horizontal bundling logic or a vertical bundling logic.

4. The system of claim 3, wherein the horizontal bundling logic is configured to select additional bundle containers having a similar dimension value for a dimension corresponding to a Z-axis of the stacking window.

5. The system of claim 3, wherein the vertical bundling logic is configured to generate a plurality of bundle candidates each having one of a plurality of heights.

6. The system of claim 5, wherein the plurality of heights include a highest item container height, a mean item container height, a median item container height, and a most frequent item container height.

7. The system of claim 1, wherein the stacking window comprises a plurality of vertical layers, and wherein the stacking solution includes sequential stacking of item containers assigned to sequential vertical layers.

8. The system of claim 1, wherein the stacking solution is configured to conform to one or more non-dimensional constraints.

9. The system of claim 8, wherein the one or more non-dimensional constraints include one or more of a maximum supportable load, a weight, a density, a temperature requirement, or a maximum height.

10. A computer-implemented method, comprising:
receiving a stacking solution generation request identifying a base element and a set of item containers;
generating a plurality of bundles, wherein each bundle of the plurality of bundles includes one or more containers selected from the set of item containers;
assigning each bundle of the plurality of bundles to a position within a stacking window of the base element;
generating a stacking solution including a sequential pick order for each of item containers in the set of item containers based on the assignment of the plurality of bundles within the stacking window, wherein the stacking solution is configured to conform to one or more non-dimensional constraints.

11. The computer-implemented method of claim 10, wherein generating the plurality of bundles comprises:
selecting a first item container from the set of item containers;
determining eligibility of the first container for bundling with one or more additional item containers;
when the first item container is not eligible for bundling, generating a single item bundle including the first container;
when the first container is eligible for bundling, generating a multi-item bundle by selecting one or more additional items for bundling with the first container.

12. The computer-implemented method of claim 11, wherein a multi-item bundle is generated by applying at least one of a horizontal bundling logic or a vertical bundling logic.

13. The computer-implemented method of claim 12, wherein the horizontal bundling logic is configured to select additional bundle containers having a similar dimension value for a dimension corresponding to a Z-axis of the stacking window.

14. The computer-implemented method of claim 12, wherein the vertical bundling logic is configured to generate a plurality of bundle candidates each having one of a plurality of heights.

15. The computer-implemented method of claim 14, wherein the plurality of heights include a highest item container height, a mean item container height, a median item container height, and a most frequent item container height.

16. The computer-implemented method of claim 10, wherein the stacking window comprises a plurality of vertical layers, and wherein the stacking solution includes sequential stacking of item containers assigned to sequential vertical layers.

17. The computer-implemented method of claim 10, wherein the one or more non-dimensional constraints include one or more of a maximum supportable load, a weight, a density, a temperature requirement, or a maximum height.

18. A non-transitory computer readable medium having instructions stored thereon, wherein the instructions, when executed by at least one processor, cause at least one device to perform operations comprising:
receiving a stacking solution generation request identifying a base element and a set of item containers;
generating a plurality of bundles, wherein each bundle of the plurality of bundles includes one or more containers selected from the set of item containers;
assigning each bundle of the plurality of bundles to a position within a stacking window of the base element, wherein the stacking window comprises a plurality of vertical layers;
generating a stacking solution including a sequential pick order for each of item containers in the set of item containers based on the assignment of the plurality of bundles within the stacking window, wherein the stacking solution includes sequential stacking of item containers assigned to sequential vertical layers.

19. The non-transitory computer readable medium of claim 18, wherein the stacking solution is configured to conform to one or more non-dimensional constraints.

20. The non-transitory computer readable medium of claim 18, wherein generating the plurality of bundles comprises:
selecting a first item container from the set of item containers;
determining eligibility of the first container for bundling with one or more additional item containers;
when the first item container is not eligible for bundling, generating a single item bundle including the first container;
when the first container is eligible for bundling, generating a multi-item bundle by selecting one or more additional items for bundling with the first container.
